(19) United States
(12) Patent Application Publication
(10) Pub. No.: US 2023/0356135 A1
(43) Pub. Date: Nov. 9, 2023

(54) AIR CLEANING DEVICE

(71) Applicant: ZEHNDER GROUP INTERNATIONAL AG, CH-5722 GRÄNICHEN (CH)

(72) Inventors: Janne PAIHO, Motala (SE); Magnus BLADH, Stockholm (SE)

(73) Assignee: ZEHNDER GROUP INTERNATIONAL AG, CH-5722 GRÄNICHEN (CH)

(21) Appl. No.: 17/911,586

(22) PCT Filed: Apr. 6, 2021
(86) PCT No.: PCT/EP2021/058976

§ 371 Date: Sep. 14, 2022

(30) Foreign Application Priority Data
Apr. 7, 2020 (CH) 00422/20

(51) Int. Cl. B01D 46/64; B01D 46/00; F24F 13/28

(52) U.S. Cl. CPC B01D 46/64; B01D 46/0032; B01D 46/0004; B01D 46/0013; B01D 46/0005; F24F 13/28; B01D 2267/70; B01D 2267/60; B01D 2273/30

(57) ABSTRACT

An air filter arrangement (A) includes at least two frames removably attached to each other, each one of the at least two frames delimiting one of at least two spaces/volumes (V1, V2, V3) and all of the at least two frames together defining an air flow path (V1-V2-V3) passing through each one of the at least two adjacent/contiguous spaces/volumes (V1, V2, V3), wherein the space/volume (V1, V2, V3) of one frame of the at least two frames includes a first air filter (F1), the space/volume (V1, V2, V3) of another frame of the at least two frames includes a second air filter (F2), and the space/volume (V1, V2, V3) of one frame of the at least two frames includes an air moving unit (M1). A combined air filter arrangement (CA) may include at least two such air filter arrangements.

### CROSS REFERENCE TO RELATED APPLICATION

This application is a National Phase filing in the United States, under 35 USC § 371, of PCT International Patent Application PCT/EP2021/058976, filed on 6 Apr. 2021 which claims the priority of Swiss Patent Application CH 00422/20, filed 7 Apr. 2020.

These applications are hereby incorporated by reference herein in their entirety and is made a part hereof, including but not limited to those portions which specifically appear hereinafter.

### BACKGROUND OF THE INVENTION

### Field of the Invention

The present invention relates to an air cleaning device to clean air in a volume of air.

### Discussion of Related Art

EP 2040845 A1 was first published in April 2009 on behalf of Freshman AB. It relates to an air filter arrangement and a method for manufacturing such air filter arrangement. The air filter arrangement comprises an air channel, a first air filter mounted in the air channel. The first air filter comprises a filter frame provided with at least one passage for through flow of air and a filter body comprising electrostatically chargeable fibers which are attached to the filter frame such that the filter body obtains an extension from the filter frame to a position located at a distance from and downstream the filter frame with respect to the flow direction of the air through the air channel. The air filter arrangement comprises a second air filter comprising a filter cloth which, in a mounted state, is adapted to extend across the air channel such that it is flown through by air flowing in a substantial longitudinal direction in the air channel. The second air filter is mounted in the air channel in a position located downstream the first air filter with respect to the flow direction of the air through the air channel.

EP 2131960 A1 was first published in October 2008 on behalf of Camfil AB. It relates to a filter assembly which includes a housing, an electro-filter contained in the housing. In addition, it comprises means for supplying a high-voltage to the electro-filter, said housing comprising a door allowing access to the electro-filter, which door, on the inside thereof, has connectors for connecting said high-voltage supply means to the electro-filter when said door is closed. According to the invention said high-voltage supply means are arranged in a separate unit, which is disposed on the outside of said door and connected to a control unit for controlling the filter assembly, said unit being disposed on another part of the housing than said door.

EP 0348011 A2 was first published in December 1989 on behalf of Joannou Constantinos. It relates to light weight, modular ceiling mounted air cleaner featuring frame-and-chassis construction which may be flush mounted or surface mounted on a ceiling. Optional decorative panels provide flexibility of decor. The ceiling mountable air cleaning unit comprises an outer shell and an inner shell having top and side surfaces. The top surface being provided with an opening having a shroud which projects inwardly from said surface. Spacer means to retain the top surfaces of said outer shell and inner shell in a parallel. An air outlet means communicating with said space between said outer and inner shells. A fan subassembly is located within said inner shell. The fan subassembly comprising a fan having a plurality of fan blades radiating from a central hub and located within said shroud. Means for turning said fan blades and means for supporting said fan. An air filter subassembly comprises an air filter and means for supporting said air filter while providing for the inlet of air. The subassembly being attached to the open side of one of the inner shell or said outer shell. A skeleton frame is foreseen for supporting said outer shell, said inner shell and said fan subassembly in the aforesaid relationships.

KR 20190093422 A was first published on behalf of Korea Advanced Institute SCI and Tech in August 2019. It relates to a stack type filter modular air purifier which comprises a fan case having a lower plate on which a plurality of holes are formed for air to pass there through. The modular air purifier further comprises: An inner space. A stack type filter members stored in the inner space of the fan case. A fan spouting air to the filter members. A power source unit supplying power to the fan. The stack type filter modular air purifier comprises a joint unit enabling a plurality of filters constituting the stack

### SUMMARY OF THE INVENTION

The present invention relates to an air filter arrangement composed of at least two individual modules and to a combined air filter arrangement comprising at least two such air filter arrangements.

It is an object of the present invention to provide an air filter arrangement and a combined air filter arrangement which can be easily adapted to a required degree of clean air production (air filtering capacity) and to different installation environments.

According to a first aspect of the invention, there is provided an air filter arrangement comprising at least two frames removably attached to each other, each one of the at least two frames delimiting one of at least two adjacent/contiguous spaces or volumes and all of said at least two frames together defining an air flow path passing through each one of the at least two adjacent/contiguous spaces or volumes, wherein the space or volume of one frame of the at least two frames comprises an air filter; and the space or volume of one frame of the at least two frames comprises an air moving unit.

Each frame is a module of a set of modules allowing different modular air filter arrangements to be put together.

The availability of at least two frames removably attached to each other and comprising an air filter and an air moving unit, respectively, allows the air filter arrangement to be adapted by readjusting the order, i.e., switching the position, of the two frames within the air flow path they define. Preferably, the air moving unit is a fan.

Preferably, the space or volume of one frame of the at least two frames comprises a first air filter and the space or volume of another frame of the at least two frames comprises a second air filter. The first air filter may be a first type of air filter, and the second air filter may be a second type of air filter. The first air filter and the second air filter may be identical types of air filter.

One of the at least two frames may comprise an air filter or an air moving unit only. One or both of the at least two frames may each comprise an air filter and an air moving unit. In this way, air filter arrangements can be put together having their air filter and an air moving unit positioned in different sequences within the air flow path.

The modular air filter arrangement according to the invention is highly versatile. For instance, the following sequences along the air flow path are possible:
air filter in first frame, air moving unit in second frame
air moving unit in first frame, air filter in second frame
air filter and air moving unit in first frame, air filter and air moving unit in second frame
air filter in first frame, air filter and air moving unit in second frame
air filter and air moving unit in first frame, air filter in second frame
air moving unit in first frame, air filter and air moving unit in second frame
air filter and air moving unit in first frame, air moving unit in second frame
two air filters in first frame, air moving unit in second frame etc.

Preferably, at least one air filter is a filter comprising electrostatically chargeable fibers and/or ribbons attached to a frame and extending into the air space or volume delimited by said frame. Such filters have a relatively large filter volume and are sometimes referred to as “volume filters” or three-dimensional filters or “3D filters”. Filters with electrostatically chargeable fibers attached to a frame are sometimes referred to as “flimmer filters”. For instance, this air filter may be a “3D flimmer filter” with one end or both ends of the flimmers attached to the frame. When air is blown through such a filter, the flimmers move in a wave-like fashion repeatedly contacting each other more or less rubbing against each other. This contributes to building up and maintaining an electrical surface charge at the flimmer surfaces, i.e., separation of electrical charges by contact electricity or triboelectricity.

Such filters can absorb a relatively large amount of dust particles from the air before they become saturated with absorbed or “collected” particles at the surface of their fibers and/or ribbons.

Preferably, at least one air filter is a barrier filter comprising a fabric or a microporous material. Such filters have a relatively small filter volume and are sometimes referred to as “volume filters” or “D filters”. For instance, this air filter may be 2D non-woven fabric filter, preferably pleated filters or bag filters.

Preferably, at least one of the at least two frames is a box having an inlet opening where air flowing along said air flow path flows into said box, and having an outlet opening where air flowing along said air flow path flows out of said box.

Preferably, all of the at least two frames are a box having an inlet opening where air flowing along said air flow path flows into said box, and having an outlet opening where air flowing along said air flow path flows out of said box.

The frame being a box with an inlet opening and an outlet opening allows the air flow pattern to be defined. As a result, all the air flowing through the air filter also flows through the air moving unit such as a fan. The amount of air flowing through the air moving unit can be easily monitored by measuring the instantaneous pressure drop across the air moving unit and relating it to the corresponding instantaneous air flow rate based on the characteristics (air flow resistance curve) of the air moving unit. By integrating the instantaneous pressure drop over time, the (cumulative) amount of clean air provided by the air filter arrangement comprising at least one air filter and at least one air moving unit connected in series can be calculated.

Preferably, a box comprises at least one movable wall portion which can be moved (removed) with respect to the remaining fixed wall portions of said box.

This allows the at least one air filter in a box to be easily replaced.

The movable wall portion may be a flexible wall portion or a rigid wall portion.

The box may comprise multifunctional fixing means with selective hinge function or latch/lock function, and said multifunctional fixing means movably connecting said movable wall portion to said remaining fixed wall portions by means of a hinge or by means of a latch/lock. The multifunctional fixing means may be a fixture. “Selective hinge function” is to be understood as in-built hinge function and in-built latch/lock function. One or the other of these two functions can be activated.

As an alternative or in addition, the box may comprise multifunctional fixing means with selective ball joint function or latch/lock function, said multifunctional fixing means movably connecting said movable wall portion to said remaining fixed wall portions by means of a ball joint or by means of a latch/lock. Again, the multifunctional fixing means may be a fixture. “Selective hinge function” is to be understood as in-built ball-joint function and in-built latch/lock function. One or the other of these two functions can be activated.

If the movable wall portion is a flexible wall portion, at least one fixing means is needed.

If the movable wall portion is a rigid wall portion, at least two multifunctional fixing means are needed. The modular air filter arrangement according to the invention is highly versatile. For instance, the following combinations of positions of the multi-functional fixing means at a rectangular removable wall portion and the corresponding rectangular opening in the box are possible:

Positioning one left-side multifunctional fixing means at the edge of the left-hand side of the opening and one right-side multifunctional fixing means at the edge of the right-hand side of the opening which allows selecting the hinge or ball joint function of one of the multifunctional fixing means and selecting the latch/lock function of the other of the multifunctional fixing means. As result, the movable wall portion becomes a door opening to the left or a door opening to the right.

Positioning one upper-side multifunctional fixing means at the edge of the upper side of the opening and one lower-side multifunctional fixing means at the edge of the lower side of the opening which allows selecting the hinge or ball joint function of one of the multifunctional fixing means and selecting the latch/lock function of the other of the multifunctional fixing means. As result, the movable wall portion becomes an upwardly opening door or a downwardly opening door.

Preferably, at least two frames are removably attached on top of each other and define a substantially vertical air flow path. Preferably, at least two frames are removably attached next to each other and define a substantially horizontal air flow path. This allows selecting a vertical air flow path or a horizontal air flow path or any series combination of vertical and horizontal air flow paths along an overall flow path.

An air filter within a frame can be removed from and reinserted into the space or volume of one frame when the at least one movable wall portion has been moved (removed) with respect to the remaining fixed wall portions.

In a first particularly preferred embodiment, the air filter arrangement comprises three frames, each one of the three space or volume delimiting frames together defining an air flow path, one of the three frames comprising said first air filter, one of the three frames comprising said second air filter and one of the three frames comprising said air moving unit. Preferably, the first air filter is a 3D filter or flimmer filter at a more upstream location of the air flow path, and the second air filter is a 2D filter or barrier filter at a more downstream location of the air flow path.

In a second particularly preferred embodiment, the air filter arrangement comprises four frames, each one of the four space or volume delimiting frames together defining an air flow path, one of the four frames comprising a first air filter, one of the four frames comprising a second air filter, one of the four frames comprising a third air filter, and one of the four frames comprising an air moving unit. Preferably, the first air filter is a 3D filter or flimmer filter at a more upstream location of the air flow path, and the third air filter is a 2D filter or barrier filter at a more downstream location of the air flow path. The second air filter at an intermediate location of the air flow path, i.e., in between the first and second filters along the air flow path, may be a 3D filter or flimmer filter or it may be a 2D filter or barrier filter.

In a third particularly preferred embodiment, the air filter arrangement comprises four frames, each one of the four space or volume delimiting frames together defining an air flow path, one of the four frames comprising a first air filter, one of the four frames comprising a second air filter, one of the four frames comprising a first air moving unit, and one of the four frames comprising a second air moving unit. Preferably, the first air filter is a 3D filter or flimmer filter at a more upstream location of the air flow path, and the second air filter is a 2D filter or barrier filter at a more downstream location of the air flow path. The first air moving unit may be located directly downstream of the first air filter, and the second air moving unit may be located directly downstream of the second air filter.

In a fourth particularly preferred embodiment, the air filter arrangement comprises five frames, each one of the five space or volume delimiting frames together defining an air flow path, one of the five frames comprising a first air filter, one of the five frames comprising a second air filter, one of the five frames comprising a third air filter, one of the five frames comprising a first air moving unit, and one of the five frames comprising a second air moving unit. Preferably, the first air filter and the second air filter along the air flow path is a 3D or flimmer filter. The third air filter along the air flow path may be a 2D or barrier filter. The first air moving unit may be located downstream of at least the first and/or the second air filter. The second air moving unit may be located downstream of the first air moving unit.

Preferably, an air moving unit is arranged in the most downstream space or volume of the air flow path. As a result, the air moving unit, for instance a fan, is not exposed to dust-laden air carrying many small solid particles which tend to adversely affect the air moving unit. Instead, only clean air passes through the air moving unit, thus greatly increasing the lifetime of the air moving unit.

Preferably, a first air moving unit is arranged in the most downstream space or volume and a second air moving unit is arranged in a more upstream space or volume. Again, this results in the first air moving unit, for instance a fan, being exposed to cleaned air only and the second air moving unit, for instance a fan, being exposed to partially cleaned air only, thus still significantly increasing the sum of the lifetimes of the two air moving units.

Preferably, the frames or boxes are stackable, i.e., they can be positioned vertically adjacent to each other allowing only limited or no horizontal/lateral movement of one frame with respect to an adjacent lower frame or with respect to an adjacent upper frame. This allows the filter arrangement to be easily set up with a specific sequence of frames in the air flow path and to be easily modified by rearranging the frames and thus modifying the specific sequence of frames in the air flow path.

Preferably, at least some of said frames comprise bottom formations at their bottom and top formations at their top, said top formations being complementary to said bottom formations, thus enabling said bottom formations of an upper frame to engage said complementary top formations of an adjacent lower frame adjacent to said upper frame.

Preferably, the frames are positionable side by side next to each other allowing only limited or no vertical/lateral movement of one frame with respect to an adjacent frame in front of, behind, to the left of or to the right of that one frame.

Preferably, at least some of said frames comprise at least first lateral formations at a first (left-hand) side and second lateral formations at second (right-hand) side, said first lateral formations being complementary to said second lateral formations, thus enabling said first lateral formations of a first frame of a first air filter arrangement to engage said complementary second lateral formations of an adjacent second frame of a second air filter arrangement adjacent to said first air filter arrangement.

The air filter arrangement may comprise frames having a triangular footprint.

The air filter arrangement may comprise frames having a rectangular footprint.

Preferably, the triangular footprint is one half of said rectangular footprint.

The air filter arrangement may comprise frames having a hexagonal footprint.

Preferably, the triangular footprint is one sixth of said hexagonal footprint.

The air filter arrangement may comprise frames having a circular footprint or a footprint in the form of a section of a circular footprint.

The air filter arrangement may comprise frames having an annular footprint or a footprint in the form of a section of an annular footprint.

These footprints allow a large variety of stacked frames to be positioned next to each other by using any one of these footprints alone or a combination of these footprints.

Preferably, the frames or boxes are nestable, i.e., they can be vertically moved one into another.

This allows the frames or boxes to be transported in a nested state requiring much less volume than if they were only stacked.

Preferably, at least some of said frames comprise bottom nesting/stacking formations at their bottom and/or top nesting/stacking formations at their top, and wherein said bottom nesting/stacking formations and/or said top nesting/stacking formations can be switched to a nesting position enabling adjacent frames to be nested and to a stacking position enabling adjacent frames to be stacked.

Similarly, the 3D flimmer filters and the 2D barrier filters can be transported in a compacted state. As result, all the components of the air filter arrangement can be transported in a compacted state.

According to a second aspect of the invention, there is provided a combined air filter arrangement, comprising at least two air filter arrangements as defined in the above paragraphs. The availability of at least two air filter arrangements each comprising a stack with at least an air filter and an air moving unit provides a combined air filter arrangement with increased clean air delivery rate (CADR). The CADR of the combined air filter arrangement is approximately identical to the sum of the CADRs of each air filter arrangement included in the combined air filter arrangement.

Preferably, the at least two air filter arrangements in the combined air filter arrangement are removably attached to each other.

Preferably, the combined air filter arrangement comprises frames stacked on top of each other and engaged with each other and frames positioned side by side next to each other and engaged with each other.

As a result, a combined air filter arrangement in the form of a three-dimensional block comprising at least two frames in the vertical direction (z-axis) and at least two frames in a horizontal direction (x-axis or y-axis) can be assembled in a modular fashion.

The single-stack air filter arrangement can be ceiling mounted, wall mounted or floor mounted. Preferably, it is ceiling mounted.

The multi-stack combined air filter arrangement can be ceiling mounted, wall mounted or floor mounted. Preferably, it is floor mounted or ceiling mounted.

Preferably, sealing means are arranged between adjacent frames (boxes) and between the removable wall portions (doors) and the remaining fixed wall portions of the frames (boxes).

As a result, all the air flowing along an air flow path through at least two stacked frames flows through the space or volume of each frame and in particular through the frame comprising an air moving unit (fan) where the instantaneous pressure drop and the corresponding instantaneous clean air delivery rate can be determined from the air moving unit flow characteristics (air flow resistance curve). Unlike the corresponding filter characteristics which change over time due to the accumulated dust load and increasing filter saturation, the flow characteristics of the air moving units are practically constant throughout the lifetime of an upstream and/or downstream filter in the air flow path.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF SEVERAL VIEWS OF THE DRAWINGS

The herein described invention will be more fully understood from the detailed description given herein below and the accompanying drawings which should not be considered limiting to the invention described in the appended claims. The drawings are showing:

FIG. 1 is a perspective view of a first embodiment of an air filter arrangement according to the present invention.

FIG. 2 is a front view of the first embodiment of an air filter arrangement according to the present invention.

FIG. 3 shows the first embodiment according to the invention with

FIG. 3a being a perspective view from above,

FIG. 3b being a perspective view from below,

FIG. 3c being a side view from the left,

FIG. 3d being a front view (similar to FIG. 2),

FIG. 3e being a side view from the right,

FIG. 3f being a bottom view, and

FIG. 3g being a top view,

FIG. 4 shows a second embodiment according to the invention with

FIG. 4a being a perspective view from above,

FIG. 4b being a perspective view from below,

FIG. 4c being a side view from the left,

FIG. 4d being a front view,

FIG. 4e being a side view from the right,

FIG. 4f being a bottom view, and

FIG. 4g being a top view,

FIG. 5 shows a third embodiment according to the invention with

FIG. 5a being a perspective view from above,

FIG. 5b being a perspective view from below,

FIG. 5c being a side view from the left,

FIG. 5d being a front view,

FIG. 5e being a side view from the right,

FIG. 5f being a bottom view, and

FIG. 5g being a top view.

FIG. 6 shows a fourth embodiment according to the invention with

FIG. 6a being a perspective view from above,

FIG. 6b being a perspective view from below,

FIG. 6c being a side view from the left,

FIG. 6d being a front view,

FIG. 6e being a side view from the right,

FIG. 6f being a bottom view, and

FIG. 6g being a top view,

FIG. 7 shows a fifth embodiment according to the invention with

FIG. 7a being a perspective view from above,

FIG. 7b being a perspective view from below,

FIG. 7c being a side view from the left,

FIG. 7d being a front view,

FIG. 7e being a side view from the right,

FIG. 7f being a bottom view, and

FIG. 7g being a top view,

FIG. 8 shows a sixth embodiment according to the invention with

FIG. 8a being a perspective view from above,

FIG. 8b being a perspective view from below,

FIG. 8c being a side view from the left,

FIG. 8d being a front view,

FIG. 8e being a side view from the right,

FIG. 8f being a bottom view, and

FIG. 8g being a top view,

FIG. 9 is a schematic perspective view of a module of an air filter arrangement according to the invention,

FIG. 10 is a schematic perspective view of a seventh embodiment an air filter arrangement according to the present invention,

FIG. 11 is a schematic perspective view of a combined air filter arrangement according to the present invention,

FIG. 12 is a schematic view of a vertical section of an eighth embodiment of an air filter arrangement according to the invention, and

FIG. 13 is a schematic view of a vertical section of a ninth embodiment of an air filter arrangement according to the invention.

### DETAILED DESCRIPTION OF THE INVENTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

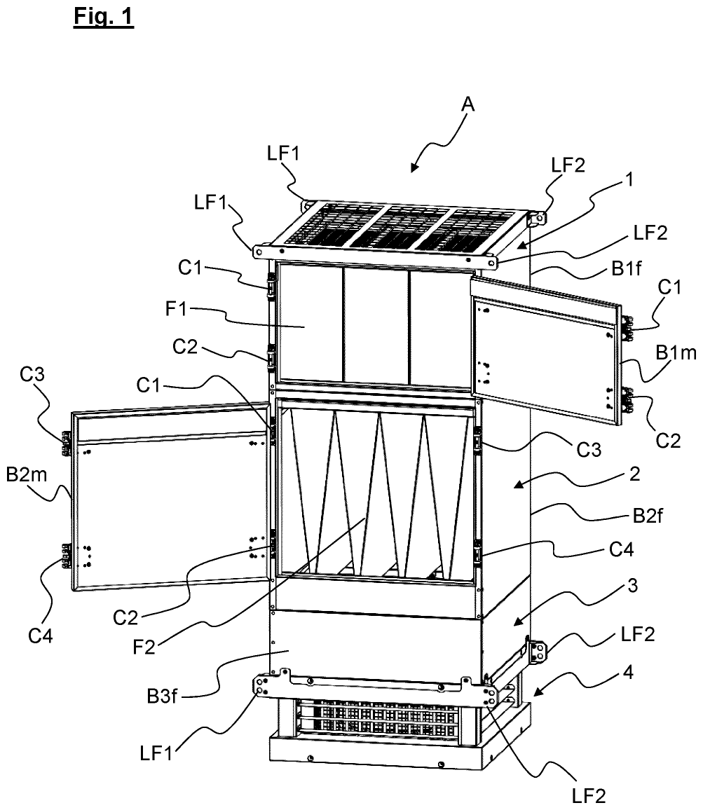

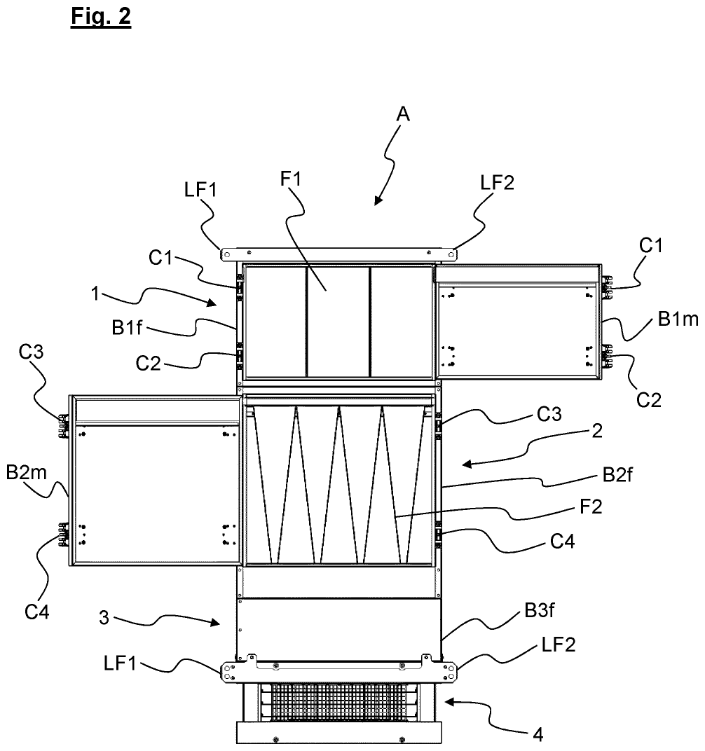

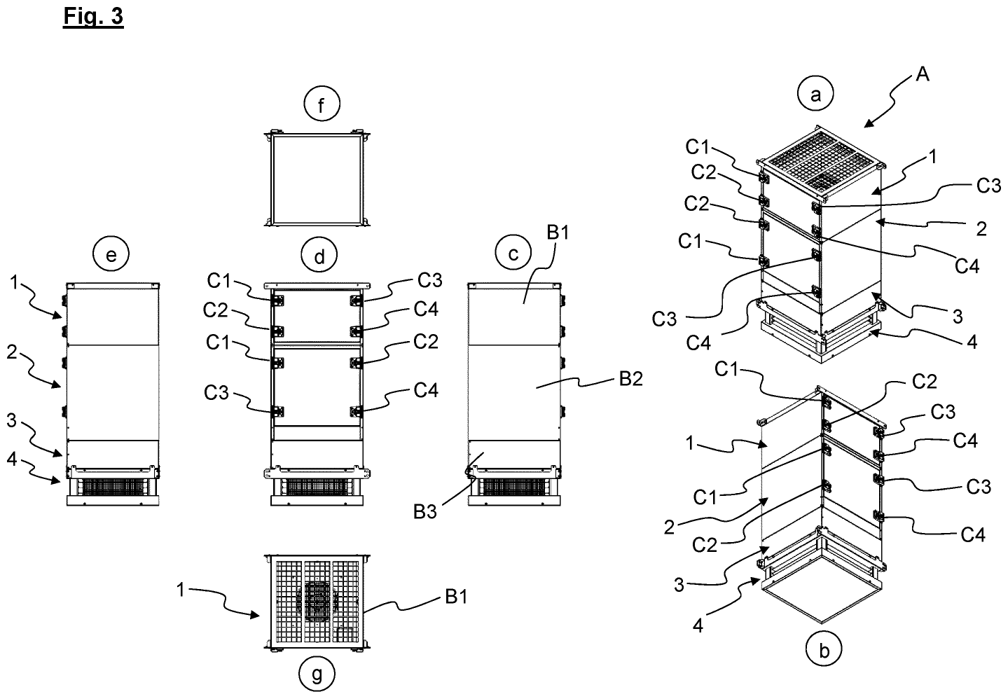

FIG. 1 is a perspective view of a first embodiment of an air filter arrangement A according to the present invention. FIG. 2 is a front view of the first embodiment of an air filter arrangement. FIGS. 3a to 3g show the first embodiment according to the invention with FIG. 3a being a perspective view from above, FIG. 3b being a perspective view from below, FIG. 3c being a side view from the left, FIG. 3d being a front view (similar to FIG. 2), FIG. 3e being a side view from the right, FIG. 3f being a bottom view, and FIG. 3g being a top view. In FIG. 1 and FIG. 2 movable wall portions B1m, B2m are shown in an open position, such that the inside of respective frames 1, 2 and therein arranged filters F1, F2 become visible. In FIGS. 3a through 3f the air filter arrangement is shown from the outside with the movable wall portions B1m, B2m shown in closed position.

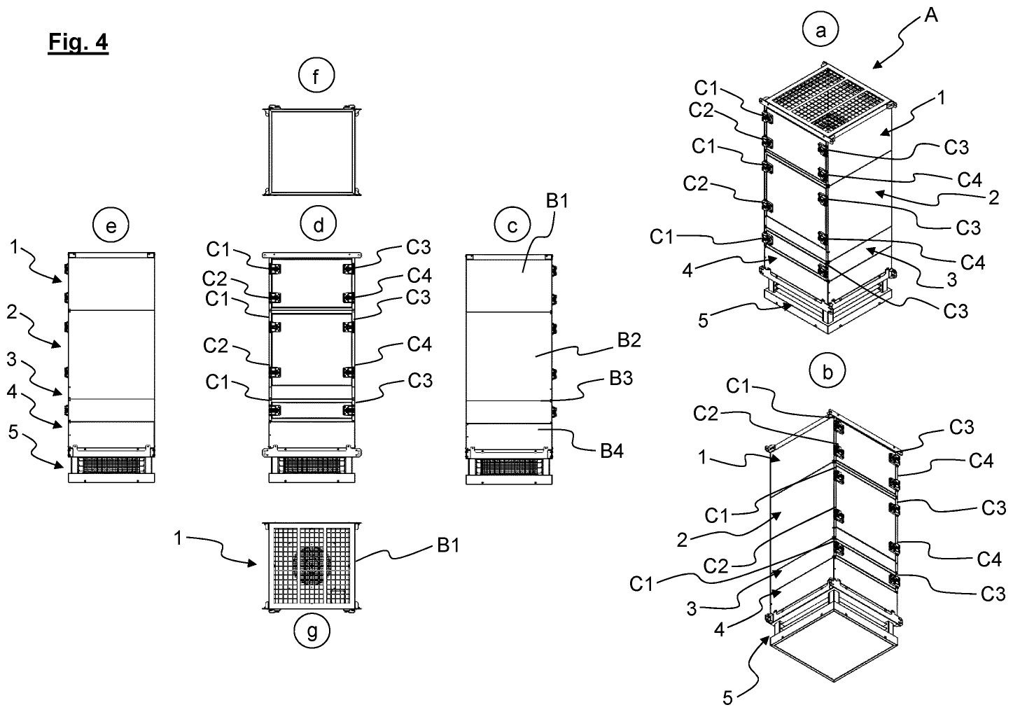

FIGS. 4a to 4g all show a second embodiment of an air filter arrangement A according to the invention with FIG. 4a being a perspective view from above, FIG. 4b being a perspective view from below, FIG. 4c being a side view from the left, FIG. 4d being a front view, FIG. 4e being a side view from the right, FIG. 4f being a bottom view, and FIG. 4g being a top view.

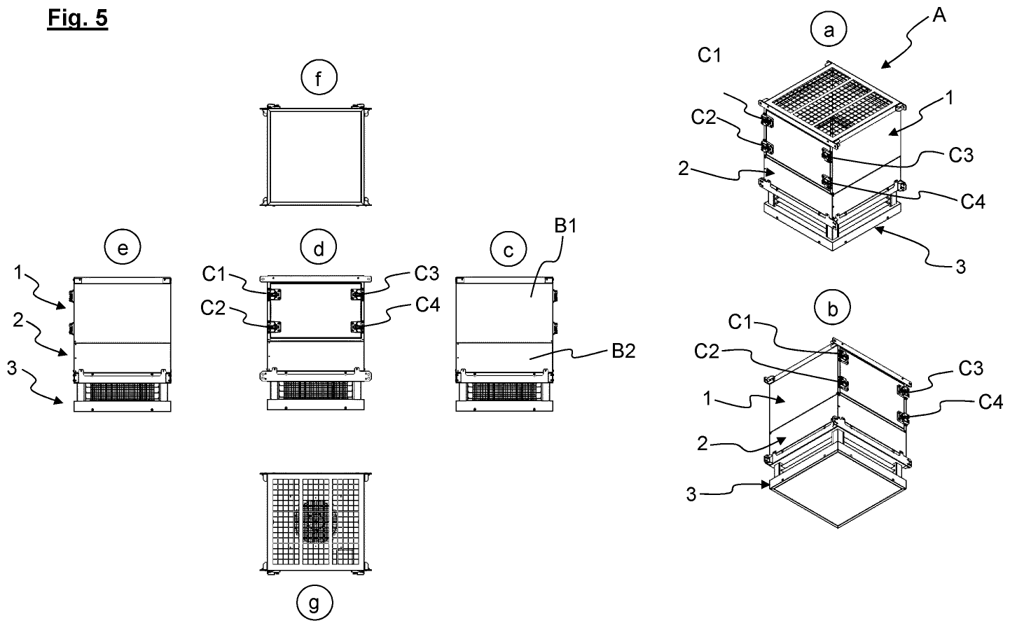

FIGS. 5a to 5g all show a third embodiment of an air filter arrangement A according to the invention with FIG. 5a being a perspective view from above, FIG. 5b being a perspective view from below, FIG. 5c being a side view from the left, FIG. 5d being a front view, FIG. 5e being a side view from the right, FIG. 5f being a bottom view, and FIG. 5g being a top view.

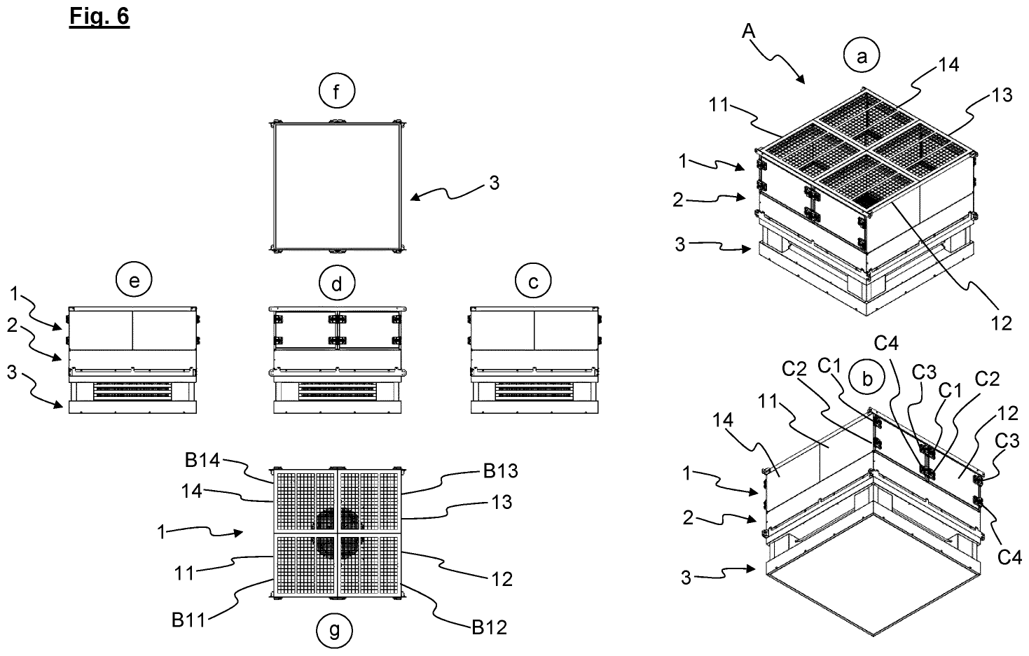

FIGS. 6a to 6g all show a fourth embodiment of an air filter arrangement A according to the invention with FIG. 6a being a perspective view from above, FIG. 6b being a perspective view from below, FIG. 6c being a side view from the left, FIG. 6d being a front view, FIG. 6e being a side view from the right, FIG. 6f being a bottom view, and FIG. 6g being a top view.

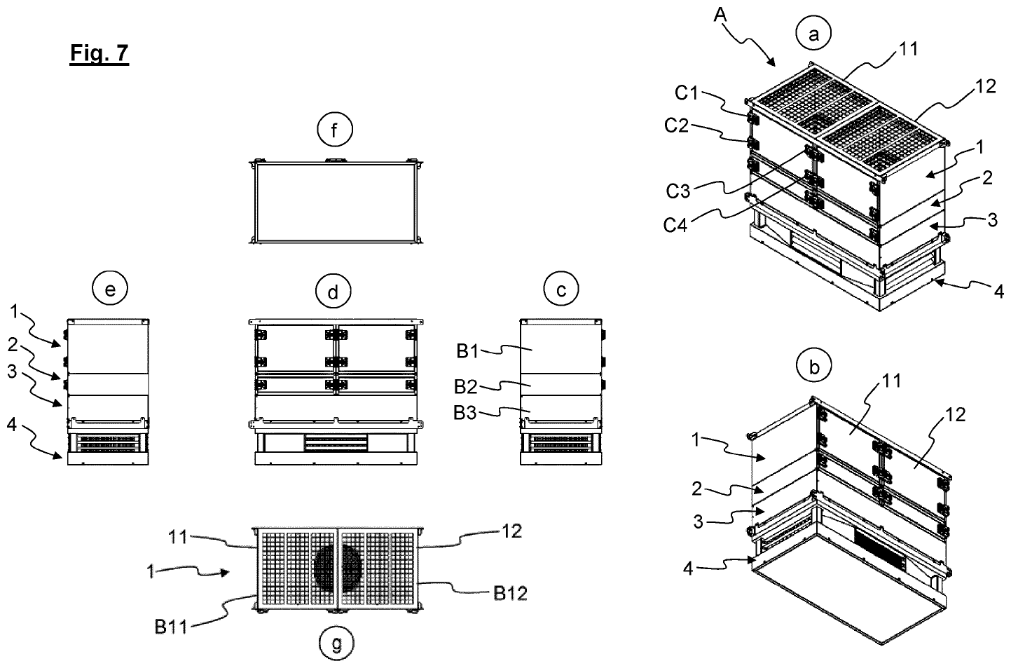

FIGS. 7a to 7g all show a fifth embodiment of an air filter arrangement A according to the invention with FIG. 7a being a perspective view from above, FIG. 7b being a perspective view from below, FIG. 7c being a side view from the left, FIG. 7d being a front view, FIG. 7e being a side view from the right, FIG. 7f being a bottom view, and FIG. 7g being a top view.

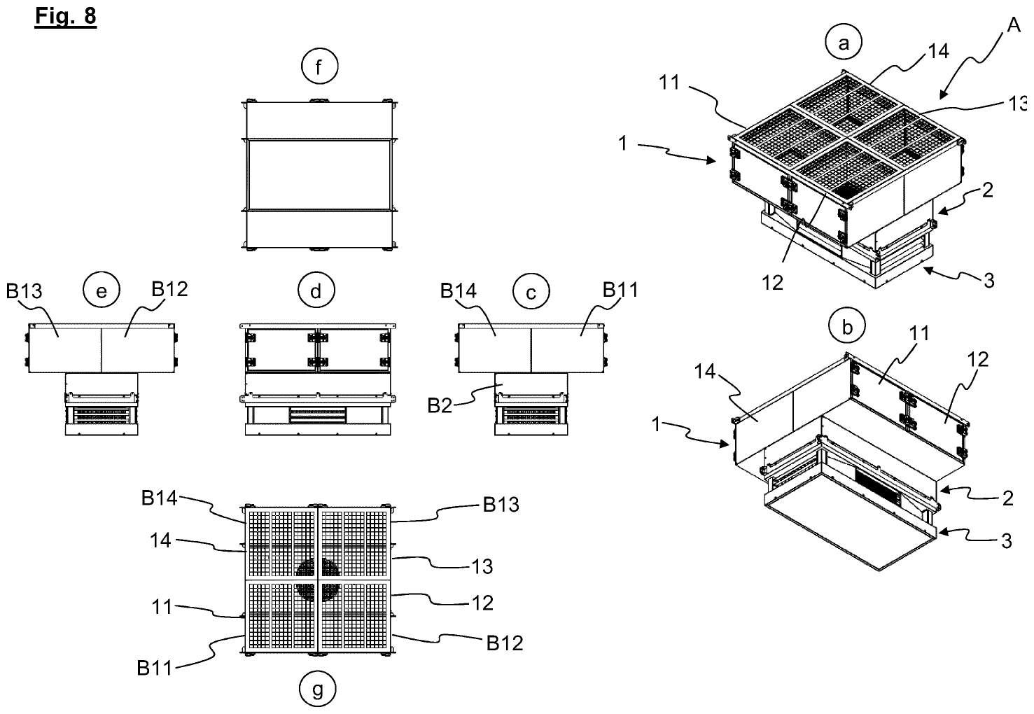

FIGS. 8a to 8g all show a sixth embodiment of an air filter arrangement A according to the invention with FIG. 8a being a perspective view from above, FIG. 8b being a perspective view from below, FIG. 8c being a side view from the left, FIG. 8d being a front view, FIG. 8e being a side view from the right, FIG. 8f being a bottom view, and FIG. 8g being a top view.

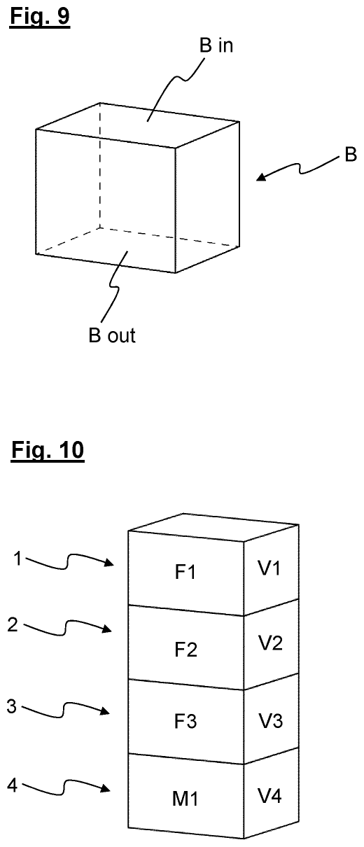

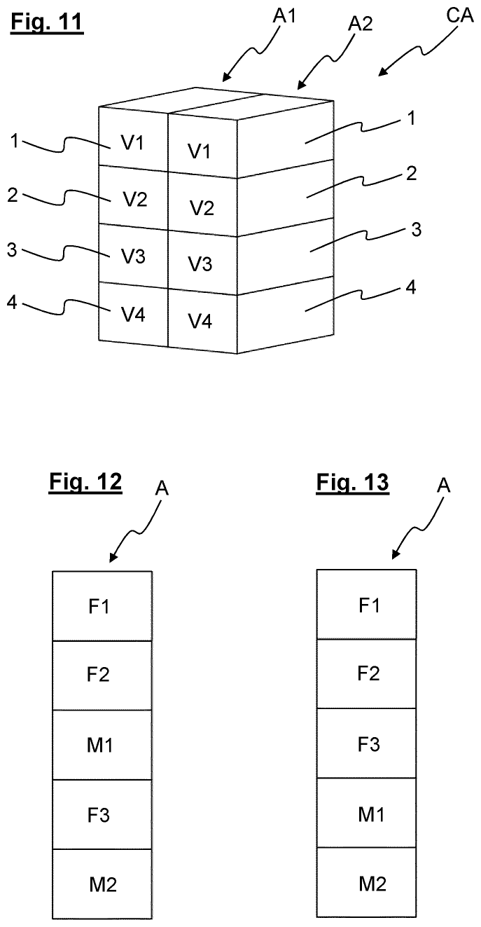

FIG. 9 is a schematic perspective view of a module B of an air filter arrangement A according to the invention. FIG. 10 is a schematic perspective view of a seventh embodiment an air filter arrangement A according to the present invention. FIG. 11 is a schematic perspective view of a combined air filter arrangement A according to the present invention. FIG. 12 is a schematic view of a vertical section of an eighth embodiment of an air filter arrangement A according to the invention. FIG. 13 is a schematic view of a vertical section of a ninth embodiment of an air filter arrangement A according to the invention.

As shown in the various embodiments mentioned above, according to a first aspect of the invention, there is provided an air filter arrangement A, A1, A2 comprising at least two frames 1, 2, 3, 4, 5 removably attached to each other. Each one of the frames 1, 2, 3, 4, 5 delimiting one of three adjacent/contiguous spaces or volumes V1, V2, V3, V4, V5. All of said at least two frames 1, 2, 3, 4, 5 together defining an air flow path V1-V2-V3, V1-V2-V3-V4, V1-V2-V3-V4-V5 passing through each one of the at least two adjacent/contiguous spaces or volumes V1, V2, V3, V4, V5. The space or volume V1, V2, V3, V4, V5 of one frame 1, 2, 3, 4, 5 comprises an air filter F1, F2, F3 and the space or volume of one frame of the at least two frames comprises an air moving unit M1.

As best visible from FIGS. 1 to 8, the box B, B1, B2, B3 of the shown embodiments comprise multifunctional fixing means C1, C2, C3, C4 with selective hinge function or latch/lock function, and said multifunctional fixing means C1, C2, C3, C4 movably connecting said movable wall portion B1m, B2m, B3m to said remaining fixed wall portions B1f, B2f, B3f by means of a hinge or by means of a latch/lock. The multifunctional fixing means C1, C2, C3, C4 may be a fixture. “Selective hinge function” is to be understood as in-built hinge function and in-built latch/lock function. One or the other of these two functions can be activated. As an alternative or in addition, the box may comprise multifunctional fixing means C1, C2, C3, C4 with selective ball joint function or latch/lock function, said multifunctional fixing means C1, C2, C3, C4 movably connecting said movable wall portion B1m, B2m to said remaining fixed wall portions B1f, B2f, B3f by means of a ball joint or by means of a latch/lock. Again, the multifunctional fixing means C1, C2, C3, C4 may be a fixture. “Selective hinge function” is to be understood as in-built ball-joint function and in-built latch/lock function. One or the other of these two functions can be activated.

If the movable wall portion B1m, B2m, B3m is a flexible wall portion, at least one fixing means is needed. If the movable wall portion B1m, B2m, B3m is a rigid wall portion, at least two multifunctional fixing means C1, C2, C3, C4 are needed. The modular air filter arrangement A, A1, A2 according to the invention is highly versatile. For instance, the following combinations of positions of the multifunctional fixing means C1, C2, C3, C4 at a rectangular removable wall portion B1m, B2m, B3m and the corresponding rectangular opening in the box are possible:
Positioning one left-side multifunctional fixing means C1, C2, C3, C4 at the edge of the left-hand side of the opening and one right-side multifunctional fixing means C1, C2, C3, C4 at the edge of the right-hand side of the opening which allows selecting the hinge or ball joint function of one of the multi-functional fixing means C1, C2, C3, C4 and selecting the latch/lock function of the other of the multifunctional fixing means. As result, the movable wall portion B1m, B2m, B3m becomes a door opening to the left or a door opening to the right.

Positioning one upper-side multifunctional fixing means C1, C2, C3, C4 at the edge of the upper side of the opening and one lower-side multifunctional fixing means C1, C2, C3, C4 at the edge of the lower side of the opening which allows selecting the hinge or ball joint function of one of the multifunctional fixing means C1, C2, C3, C4 and selecting the latch/lock function of the other of the multifunctional fixing means. As result, the movable wall portion B1m, B2m, B3m becomes an upwardly opening door or a downwardly opening door.

As best visible in FIGS. 9 through 13, each frame 1, 2, 3, 4, 5 is a module of a set of modules allowing different modular air filter arrangements to be put together. The availability of at least two frames 1, 2, 3 removably attached to each other and comprising an air filter F1, F2, F3 and an air moving unit M1, M2, respectively, allows the air filter arrangement to be adapted by readjusting the order (see e.g., FIGS. 12 and 13), i.e., switching the position, of the two frames within the air flow path they define. Preferably, the air moving unit M1, M2 is a fan.

As best visible from FIGS. 12 and 13, the space or volume frame 1, 2, 3, 4 of the at least two frames the air filter arrangement A of the eighth and ninth embodiment comprise a first air filter F1 and the space or volume of another frame of the at least two frames comprises a second air filter F2. The first air filter F1 may be a first type of air filter, and the second air filter F2 may be a second type of air filter. The first air filter F1 and the second air filter F2 may alternatively be identical types of air filter. One of the at least two frames may comprise an air filter F1, F2, F3 or an air moving unit M1, M2 only. One or both of the at least two frames may each comprise an air filter F1, F2, F3 and an air moving unit M1, M2. In this way, air filter arrangements A can be put together having their air filter F1, F2, F3 and an air moving unit M1, M2 positioned in different sequences within the air flow path. The modular air filter arrangement according to the invention is highly versatile.

As best visible in FIGS. 1 and 2, a box B of the first and second embodiment may further comprise at least one movable wall portion B1m, B2m which can be moved (removed) with respect to the remaining fixed wall portions B1f, B2f, B3f of said box. This allows the at least one air filter F1, F2, F3 in a box to be easily replaced. The movable wall portion B1m, B2m, B3m may be a flexible wall portion or a rigid wall portion. As best visible in FIGS. 1 and 2 preferably at least some of said frames 1, 2, 3, 4 comprise at least first lateral formations LF1 at a first (left-hand) side and second lateral formations LF2 at second (right-hand) side, said first lateral formations LF1 being complementary to said second lateral formations LF2, thus enabling said first lateral formations LF1 of a first frame 1 of a first air filter arrangement A to engage said complementary second lateral formations LF2 of an adjacent second frame of a second air filter arrangement adjacent to said first air filter arrangement. As best visible in FIGS. 1 and 2, preferably at least some of said frames 1, 2, 3, 4 comprise bottom formations at their bottom and top formations at their top, said top formations being complementary to said bottom formations, thus enabling said bottom formations of an upper frame to engage said complementary top formations of an adjacent lower frame adjacent to said upper frame. Preferably, the frames are positionable side by side next to each other allowing only limited or no vertical/lateral movement of one frame with respect to an adjacent frame in front of, behind, to the left of or to the right of that one frame.

As best visible in FIGS. 6 and 7 the air filter arrangement A of the fourth and fifth embodiment comprise at least two frames 1, 2, 3, 4 are removably attached on top of each other and define a substantially vertical air flow path. Preferably, at least two frames 1, 2, 3, 4 are removably attached next to each other and define a substantially horizontal air flow path. This allows selecting a vertical air flow path or a horizontal air flow path or any series combination of vertical and horizontal air flow paths along an overall flow path. An air filter within a frame 1, 2, 3, 4 can be removed from and reinserted into the space or volume of one frame when the at least one movable wall portion B1m, B2m, B3m has been moved (removed) with respect to the remaining fixed wall portions B1f, B2f, B3f.

As visible in FIG. 5, in the third embodiment, the air filter arrangement A comprises three frames 1, 2, 3, each one of the three space or volume delimiting frames 1, 2, 3 together defining an air flow path, one of the three frames comprising said first air filter, one of the three frames comprising said second air filter and one of the three frames comprising said air moving unit. Preferably, the first air filter is a 3D filter or flimmer filter at a more upstream location of the air flow path, and the second air filter is a 2D filter or barrier filter at a more downstream location of the air flow path.

As best visible in FIG. 10, the air filter arrangement A of the seventh embodiment comprises four frames 1, 2, 3, 4 each one of the four space or volume V1, V2, V3, V4 delimiting frames 1, 2, 3, 4 together defining an air flow path, one of the four frames comprising a first air filter F1, one of the four frames comprising a second air filter F2, one of the four frames comprising a third air filter F3, and one of the four frames comprising an air moving unit M1. Preferably, the first air filter F1 is a 3D filter or flimmer filter at a more upstream location of the air flow path, and the third air filter F3 is a 2D filter or barrier filter at a more downstream location of the air flow path. The second air filter F2 at an intermediate location of the air flow path, i.e., in between the first F1 and second filters F2 along the air flow path, may be a 3D filter or flimmer filter or it may be a 2D filter or barrier filter.

In an alternative variation the air filter arrangement comprises four frames 1, 2, 3, 4 each one of the four space or volume delimiting frames together defining an air flow path, one of the four frames comprising a first air filter F1, one of the four frames comprising a second air filter F2, one of the four frames comprising a first air moving unit M1, and one of the four frames comprising a second air moving unit M2. Preferably, the first air filter F1 is a 3D filter or flimmer filter at a more upstream location of the air flow path, and the second air filter F2 is a 2D filter or barrier filter at a more downstream location of the air flow path. The first air moving unit M1 may be located directly downstream of the first air filter F1, and the second air moving unit M2 may be located directly downstream of the second air filter F2.

As visible in FIGS. 12 and 13 the air filter arrangement A of the eighth and ninth embodiment comprises five frames, each one of the five space or volume delimiting frames together defining an air flow path, one of the five frames comprising a first air filter F1, one of the five frames comprising a second air filter F2, one of the five frames comprising a third air filter F3, one of the five frames comprising a first air moving unit M1, and one of the five frames comprising a second air moving unit M2. Preferably, the first air filter F1 and the second air filter F2 along the air flow path is a 3D or flimmer filter. The third air filter F3 along the air flow path may be a 2D or barrier filter. The first air moving unit M1 may be located downstream of at least the first F1 and/or the second F2 air filter. The second air moving unit M2 may be located downstream of the first air moving unit M1.

As best visible in FIG. 9 or 10, preferably at least one of the at least two frames is a box B having an inlet opening Bin where air flowing along said air flow path flows into said box B, and having an outlet opening Bout where air flowing along said air flow path flows out of said box B. Preferably all of the at least two frames 1,2,3,4 are a box B having an inlet opening Bin where air flowing along said air flow path flows into said box, and having an outlet opening Bout where air flowing along said air flow path flows out of said box. The frame being a box with an inlet opening Bin and an outlet opening Bout allows the air flow pattern to be defined. As a result, all the air flowing through the air filter F1, F2, F3 also flows through the air moving unit M1, such as a fan. The amount of air flowing through the air moving unit M1 can be easily monitored by measuring the instantaneous pressure drop across the air moving unit M1 and relating it to the corresponding instantaneous air flow rate based on the characteristics (air flow resistance curve) of the air moving unit M1. By integrating the instantaneous pressure drop over time, the (cumulative) amount of clean air provided by the air filter arrangement A comprising at least one air filter F1, F2, F3 and at least one air moving unit M1, M2 connected in series can be calculated.

As best visible in FIG. 11, a combined air filter arrangement CA can comprise at least two air filter arrangements A1, A2 as defined in the above paragraphs. The availability of at least two air filter arrangements A1, A2 each comprising a stack with at least an air filter and an air moving unit provides a combined air filter arrangement CA with increased clean air delivery rate (CADR). The CADR of the combined air filter arrangement CA is approximately identical to the sum of the CADRs of each air filter arrangement A1, A2 included in the combined air filter arrangement CA. Preferably, the at least two air filter arrangements A1, A2 in the combined air filter arrangement CA are removably attached to each other. Preferably, the combined air filter arrangement CA comprises frames 1, 2, 3,4 stacked on top of each other and engaged with each other and frames positioned side by side next to each other and engaged with each other. As schematically indicated in FIG. 11 a combined air filter arrangement CA in the form of a three-dimensional block comprising at least two frames in the vertical direction (z-axis) and at least two frames in a horizontal direction (x-axis or y-axis) can be assembled in a modular fashion.

Preferably, an air moving unit M1, M2 is arranged in the most downstream space or volume of the air flow path. As a result, the air moving unit M1, M2 for instance a fan, is not exposed to dust-laden air carrying many small solid particles which tend to adversely affect the air moving unit M1, M2. Instead, only clean air passes through the air moving unit M1, M2, thus greatly increasing the lifetime of the air moving unit M1, M2. Alternatively, a first air moving unit M1 is arranged in the most down-stream space or volume and a second air moving unit M2 is arranged in a more up-stream space or volume. Again, this results in the first air moving unit M1, for instance a fan, being exposed to cleaned air only and the second air moving unit M2, for instance a fan, being exposed to partially cleaned air only, thus still significantly increasing the sum of the lifetimes of the two air moving units.

The frames or boxes 1, 2, 3, 4 of the air filter arrangement A, A1, A2 of any of the various embodiments mentioned above are preferably nestable, i.e., they can be vertically moved one into another.

This allows the frames or boxes 1, 2, 3, 4 to be transported in a nested state requiring much less volume than if they were only stacked. Preferably, at least some of said frames 1, 2, 3, 4 comprise bottom nesting/stacking formations at their bottom and/or top nesting/stacking formations at their top, and wherein said bottom nesting/stacking formations and/or said top nesting/stacking formations can be switched to a nesting position enabling adjacent frames 1, 2, 3, 4 to be nested and to a stacking position enabling adjacent frames 1, 2, 3, 4 to be stacked. Similarly, the 3D flimmer filters and the 2D barrier filters can be transported in a compacted state. As result, all the components of the air filter arrangement can be transported in a compacted state.

The single-stack air filter arrangement A, A1, A2 of any of the various embodiments mentioned above can be ceiling mounted, wall mounted or floor mounted. Preferably, it is ceiling mounted. Preferably, sealing means are arranged between adjacent frames (boxes) 1, 2, 3, 4 and between the removable wall portions (doors) B1m, B2m, B3m and the remaining fixed wall portions B1f, B2f, B3f of the frames (boxes) 1, 2, 3, 4.

Rather, the words used in the specification are words of description rather than limitation, and it is understood that various changes may be made without departing from the Spirit and scope of the invention.

1-34. (canceled)

35. An air filter arrangement (A) comprising:
a. at least two frames (1, 2, 3) removably attached to each other, each one of the at least two frames (1, 2, 3) delimiting one of at least two spaces/volumes (V1, V2, V3) and all of the at least two frames (1, 2, 3) together defining an air flow path (V1-V2-V3) passing through each one of the at least two adjacent/contiguous spaces/volumes (V1, V2, V3), wherein
b. the space/volume (V1, V2, V3) of one frame (1, 2, 3) of the at least two frames (1, 2, 3) comprises an air filter (F1) and the space/volume (V1, V2, V3) of one frame (1, 2, 3) of the at least two frames (1, 2, 3) comprises an air moving unit (M1).

36. The air filter arrangement (A) according to claim 35, wherein the space/volume (V1, V2, V3) of one frame (1, 2, 3) of the at least two frames (1, 2, 3) comprises a first air filter (F1) and the space/volume (V1, V2, V3) of another frame (1, 2, 3) of the at least two frames (1, 2, 3) comprises a second air filter (F2).

37. The air filter arrangement (A) according to claim 36, wherein at least one air filter (F1, F2) is a filter comprising electrostatically chargeable fibers and/or ribbons attached to a frame and extending into the air space/volume delimited by the frame or is a barrier filter comprising a fabric or a microporous material.

38. The air filter arrangement (A) according to claim 35, wherein at least one of the at least two frames (1, 2, 3) is a box (B1, B2, B3) having an inlet opening (B1in, B2in, B3in) where air flowing along the air flow path (V1-V2-V3) flows into the box (B1, B2, B3), and having an outlet opening (B1out, B2out, B3out) where air flowing along the air flow path (V1-V2-V3) flows out of the box (B1, B2, B3).

39. The air filter arrangement (A) according to claim 38, wherein a box (B1, B2, B3) comprises at least one movable wall portion (B1m, B2m, B3m) which can be moved (removed) with respect to the remaining fixed wall portions (B1f, B2f, B3f) of the box (B1, B2, B3).

40. The air filter arrangement (A) according to claim 39, wherein the box (B1, B2, B3) comprises multifunctional fixing means (C1, C2, C3, C4) with selective hinge function or latch/lock function, the multifunctional fixing means (C1, C2, C3, C4) movably connecting the movable wall portion (B1m, B2m, B3m) to the remaining fixed wall portions (B1f, B2f, B3f) by means of a hinge or by means of a latch/lock.

41. The air filter arrangement (A) according to claim 40, wherein the box (B1, B2, B3) comprises multifunctional fixing means with selective ball joint function or latch/lock function, the multifunctional fixing means movably connecting the movable wall portion (B1m, B2m, B3m) to the remaining fixed wall portions (B1f, B2f, B3f) by means of a ball joint or by means of a latch/lock.

42. The air filter arrangement (A) according to claim 39, wherein an air filter (F1, F2) within a frame (1, 2, 3) can be removed from and reinserted into the space/volume (V1, V2, V3) of one frame (1, 2, 3) when the at least one movable wall portion (B1m, B2m, B3m) has been moved (removed) with respect to the remaining fixed wall portions (B1f, B2f, B3f).

43. The air filter arrangement (A) according to claim 35, wherein at least two frames (1, 2, 3) are removably attached on top of each other and define a substantially vertical air flow path (V1-V2-V3)

44. The air filter arrangement (A) according to claim 35 wherein at least two frames (1, 2, 3) are removably attached next to each other and define a substantially horizontal air flow path (V1-V2-V3).

45. The air filter arrangement (A) according to claim 36, comprising three frames (1, 2, 3), each one of the three frames (1, 2, 3) delimiting a space/volume (V1, V2, V3) together defining an air flow path (V1-V2-V3), one of the three frames comprising the first air filter (F1), one of the three frames comprising the second air filter (F2) and one of the three frames comprising the air moving unit (M1).

46. The air filter arrangement (A) according to claim 46, comprising four frames (1, 2, 3, 4), each one of the four frames (1, 2, 3, 4) delimiting a space/volume (V1, V2, V3, V4) together defining an air flow path (V1-V2-V3-V4), one of the four frames comprising a first air filter (F1), one of the four frames comprising a second air filter (F2), one of the four frames comprising a third air filter (F3), and one of the four frames comprising an air moving unit (M1).

47. The air filter arrangement (A) according to claim 45, comprising four frames (1, 2, 3, 4), each one of the four frames (I, 2, 3, 4) delimiting a space/volume (V1, V2, V3, V4) together defining an air flow path (V1-V2-V3-V4), one of the four frames comprising a first air filter (F1), one of the four frames comprising a second air filter (F2), one of the four frames comprising a first air moving unit (M1), and one of the four frames comprising a second air moving unit (M2).

48. The air filter arrangement (A) according to claim 45, comprising five frames (1, 2, 3, 4, 5), each one of the five frames (1, 2, 3, 4, 5) delimiting a space/volume (V1, V2, V3, V4, V5) together defining an air flow path (V1-V2-V3-V4-V5), one of the five frames comprising a first air filter (F1), one of the five frames comprising a second air filter (F2), one of the five frames comprising a third air filter (F3), one of the five frames comprising a first air moving unit (M1), and one of the five frames comprising a second air moving unit (M2).

49. The air filter arrangement (A) according to claim 44, wherein an air moving unit (M1, M2) is arranged in the most downstream space/volume (V3, V4, V5) and/or wherein a first air moving unit (M1) is arranged in the most downstream space/volume (V4, V5) and a second air moving unit (M2) is arranged in a more upstream space/volume (V1, V2, V3).

50. The air filter arrangement (A) according to claim 35, wherein the frames (1, 2, 3, 4, 5) are stackable and wherein at least some of the frames (1, 2, 3, 4, 5) comprise bottom formations at their bottom and top formations at their top, the top formations being complementary to the bottom formations, thus enabling the bottom formations of an upper frame (1, 2, 3, 4) to engage the complementary top formations of an adjacent lower frame (2, 3, 4, 5) adjacent to the upper frame (1, 2, 3, 4).

51. The air filter arrangement (A) according to claim 35, wherein the frames (1, 2, 3, 4, 5) are positionable side by side next to each other and wherein at least some of the frames (1, 2, 3, 4, 5) comprise at least first lateral formations (LF1) at a first (left-hand) side and second lateral formations (LF2) at second (right-hand) side, the first lateral formations (LF1) being complementary to the second lateral formations (LF2), thus enabling the first lateral formations (LF1) of a first frame (1, 2, 3, 4, 5) of a first air filter arrangement (A1) to engage the complementary second lateral formations (LF2) of an adjacent second frame (1, 2, 3, 4, 5) of a second air filter arrangement (A2) adjacent/next to the first air filter arrangement (A2).

52. The air filter arrangement (A) according to claim 35, comprising frames (1, 2, 3, 4, 5) having a rectangular, triangular, hexagonal, circular footprint or a footprint in the form of a section of a circular footprint or an annular footprint or a footprint in the form of a section of an annular footprint.

53. The air filter arrangement (A) according to claim 35, wherein the frames (1, 2, 3, 4, 5) are nestable and wherein at least some of the frames (1, 2, 3, 4, 5) comprise bottom nesting/stacking formations at their bottom and/or top nesting/stacking formations at their top, and wherein the bottom nesting/stacking formations and/or the top nesting/stacking formations can be switched to a nesting position enabling adjacent frames to be nested and to a stacking position enabling adjacent frames to be stacked.

54. A combined air filter arrangement (CA), comprising at least two air filter arrangements (A1, A2) as defined in claim 35, which are removably attached to each other.

55. The combined air filter arrangement (CA) according to claim 54, comprising frames (1, 2, 3, 4, 5) stacked on top of each other and engaged with each other and frames (1, 2, 3, 4, 5) positioned side by side next to each other and engaged with each other.
